(19) United States
(12) Patent Application Publication
(10) Pub. No.: US 2005/0097506 A1
(43) Pub. Date: May 5, 2005

(54) Virtual desktops and project-time tracking

(75) Inventor: Roland Heumesser, Rottenburg-Oberndorf (DE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 10/697,243

(22) Filed: Oct. 31, 2003

(51) Int. Cl. G06F 9/44

(52) U.S. Cl. 717/102; 717/101

(57) ABSTRACT

A computer program product including program code, when executed on a computer, tracks the time spent by a user working with the computer for different projects. The program code is arranged to provide a plurality of virtual desktops which are assignable to different projects and switchable by the user, and to track the time spent by the user working on the different desktops, thereby tracking the time spent on the projects to which the respective desktops are assigned.

### FIELD OF THE INVENTION

The present invention relates generally to virtual desktops and project-time tracking and, for example, to computer program products, methods, and computer systems for providing virtual desktops and for project-time tracking.

### BACKGROUND OF THE INVENTION

Systems and methods for project-time recording are known which enable a user to determine and record the amounts of time spent by a person on a plurality of projects. These prior art systems require interaction tools which enable the user to identify beginnings and endings of project or work-related time periods, as well as project identification data. For example, the documents DE 44 43 850 A1 and DE 195 16 975 A1 disclose systems for recording project-related information including a portable device with a keyboard, which enables the user to enter project-related data and to indicate the beginnings and endings of project-related or work-related time periods. The information entered by the user is stored in the portable device for later transmission to a computer system in which the collected data are analyzed. Similar known time recording systems are directly implemented on computer systems without making use of portable devices.

In the current personal-computer technology, graphical user interfaces (GUIs) are used to facilitate the interaction between a user and a computer. Prevailing operating systems, such as Microsoft Windows®, Unix®, Linux® and MacOS®, have graphical user interfaces which provide a virtual desktop (sometimes simply called “desktop”) to the user. The user can place virtual objects, e.g. windows, link icons and tool bars, on this desktop. Open tasks (or applications) may be displayed by application windows, or, in a “minimized” form, by application icons which may appear in a “task bar” on the desktop. Some of the known operating systems, (such as Unix/Linux with GUIs, such as KDE, GNOME, CDE) are able to handle a plurality of desktops at the same time and enable the user to select one of the virtual desktops to be displayed on the screen. Microsoft Windows NT offers multi-desktop capabilities as an optional feature called MultiDesk within the “Windows NT Resource Kit”. The user is able to activate different tasks on different desktops thereby enlarging the effective screen space for displaying the application windows. It is also possible to group related tasks into different desktops, as described in U.S. Pat. No. 5,564,002.

### SUMMARY OF THE INVENTION

The invention is directed to a computer program product including program code, when executed on a computer, for tracking the time spent by a user working with the computer for different projects. The program code is arranged to provide a plurality of virtual desktops which are assignable to different projects and switchable by the user, and to track the time spent by the user working on the different desktops, thereby tracking the time spent on the projects to which the respective desktops are assigned.

According to another aspect, a computer program product is provided for extending a computer's operating system which provides a virtual desktop. The computer program product includes program code, when executed, for tracking the time spent by the user working with the computer for different projects. The program code is arranged to extend the operating system's desktop functionality to a multi-desktop functionality, wherein the desktops are switchable by the user and are assignable to different projects; and to track the time spent by the user working on the different desktops, thereby tracking the time spent on the projects to which the respective desktops are assigned.

According to another aspect, a computer program product is provided for extending a computer's operating system which provides a plurality of virtual desktops switchable by a user. The computer program product includes program code, when executed, for tracking the time spent by the user working with the computer for different projects, wherein desktops are assigned to projects. The program code is arranged to track the time spent by the user working on the different desktops, thereby tracking the time spent on the projects to which the respective desktops are assigned.

According to another aspect, a computer is provided arranged to track the time spent by a user working with the computer for different projects. The computer comprises a desktop manager arranged to provide a plurality of virtual desktops which are assignable to different projects and switchable by the user; and a project-time tracker arranged to individually track the time spent by the user working on the different desktops, thereby tracking the time spent on the projects to which the respective desktops are assigned.

According to another aspect, a method is provided of tracking the time spent by a user working with a computer for different projects. The computer is arranged to provide a plurality of virtual desktops assigned to different projects. The method comprises the user working on a desktop which is assigned to a currently handled project and switching to another of the desktops when another project is handled; and the computer tracking the time spent by the user working on the different desktops, thereby tracking the time spent on the projects to which the respective desktops are assigned.

According to another aspect, a computer program product is provided including program code, when executed on a computer, for providing a graphical user interface with a plurality of virtual desktops presenting link icons to a user. The program code is arranged to provide the plurality of virtual desktops in a way that the user can switch from one to another as desired, and to enable the user to define, as individual desktop settings, the link icons individually for the virtual desktops, so that, upon switching from one of the desktops to another, different link icons are displayable.

According to another aspect, a computer is provided having a graphical user interface with a plurality of virtual desktops. The computer comprises a desktop manager arranged to provide the plurality of virtual desktops switchable by the user. The virtual desktops present link icons. The desktop manager is arranged to enable the user to define the link icons individually for the virtual desktops, so that, upon switching from one of the desktops to another, different link icons are displayable.

According to another aspect, a method provides a computer user with a plurality of virtual desktops presenting link icons to the user. The virtual desktops are switchable by the user. The method comprises enabling the user to define the link icons individually for the virtual desktops, and, when a switch is made from one desktop to another, displaying different link icons for the different desktops, according to the desktop-individual link-icon definition.

Other features are inherent in the products and methods disclosed or will be come apparent to those skilled in the art from the following detailed description of embodiments and its accompanying drawings.

### DESCRIPTION OF THE DRAWINGS

Embodiments of the invention will now be described, by way of example, and with reference to the accompanying drawings, in which:

FIG. 1 illustrates a GUI with an exemplary virtual desktop;

FIG. 2 illustrates a switch from one virtual desktop to another;

FIG. 3 is a flow diagram of an embodiment in which project-time recording is started and stopped by switching from one desktop to another;

FIG. 4 is a flow diagram similar to FIG. 3 of another embodiment in which the project-time recording can be started and stopped independently of a desktop switch;

FIG. 5 illustrates an embodiment of project-time tracking based on event logging;

FIG. 6 illustrates another embodiment of project-time tracking based on cumulating project-times;

FIG. 7 shows an exemplary interface of a configurator;

FIG. 8 shows a diagrammatic representation of layers of a computer including software for virtual-desktop management and project-time tracking;

FIG. 9 is a high-level architecture diagram of a virtual-desktop-and-project-time-tracking system;

FIG. 10 is an architecture diagram similar to FIG. 9 illustrating an embodiment in which the virtual-desktop-and-project-time-tracking system is an extension to a Microsoft Windows operating system;

FIG. 11 is an architecture diagram similar to FIG. 9 illustrating another embodiment in which the virtual-desktop and project-time-tracking system is an extension to a Unix operating system.

### DESCRIPTION OF THE PREFERRED EMBODIMENTS

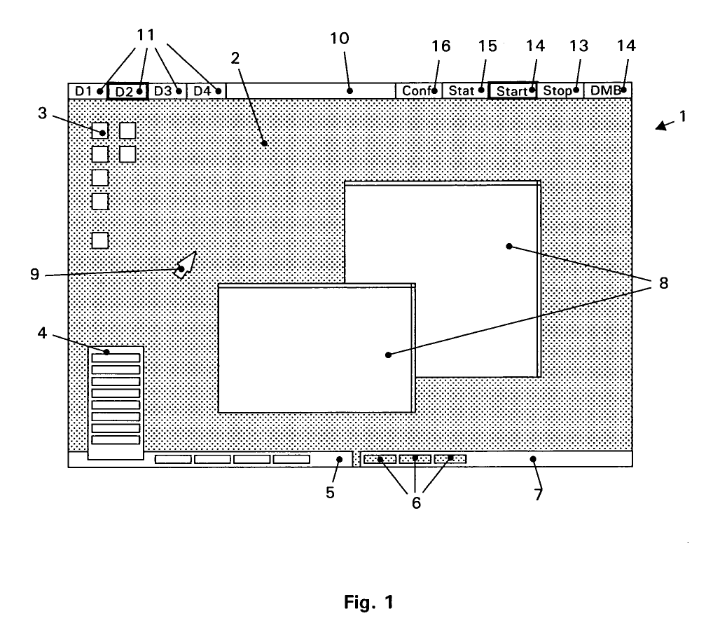

FIG. 1 illustrates a GUI with an exemplary virtual desktop. Before proceeding further with the description of FIG. 1, however, a few items of the embodiments will be discussed.

In some of the embodiments the time spent by a user working with a computer for different projects is tracked. In these embodiments, a plurality of virtual desktops is provided which are assignable to different projects and switchable by the user. By tracking the time spent by the user working on the different desktops, a record can be created of the time spent on each of the projects to which the individual desktops are assigned. The term “project” is herein used as a very general term referring to related items of work, not limited to the term's meaning in the classic business jargon. For example, besides its classical meaning, it may include different job functions of a user, jobs related to different departments or work groups in the users company, jobs for different clients, etc. In the general meaning used here, a project may, of course, combine work for several “projects” in the classical meaning, or work for one “project” in the classical meaning may be separated into several projects.

The computer has a graphical user interface (GUI) with a plurality of virtual desktops switchable by the user. The virtual desktops, including the desktop-switching functionality, are controlled by a desktop manager. The switching from one desktop to another forms a “switch event”. The virtual desktops present link icons. In some of the embodiments the desktop manager enables the user to define the link icons individually for the virtual desktops, so that, upon switching from one of the desktops to another, different link icons are displayable. Some of these embodiments with individually definable link icons are equipped with the above-mentioned project-time-tracking functionality associated with the different desktops, others have no project-time-tracking functionality. Similarly, some of the embodiments with project-time-tracking functionality have no individually definable link icons (i.e. the link icons are the same in all the desktops).

The GUI enables the computer user to interact with the computer. The graphical interface presented to the user is the “virtual desktop”, in analogy to an (actual) desktop on which work is carried out. Elements displayed on a virtual desktop include link icons, control panels, pop-up and pull-down menus, a pointing-device-controlled cursor (e.g. a mouse or track-ball cursor), task bars, and application windows. These desktop elements can be individually placed on a desktop background. Generally, the user is able to define and change their position, appearance and status, as well as the appearance of the desktop background. Link icons represent links to, for example, programs, data files, hardware devices, file folders, Internet resources (URLs, Web-pages). Clicking on a link icon with the pointing device enables the user to quickly access the linked resource, e.g. starting the represented program or opening the represented data file. Control panels and menus, for example, enable the user to control or configure system resources or programs. Application windows represent an interface between running applications (tasks) and the user. A task bar indicates the presently running programs (tasks), for example by means of task icons. Application windows can be “minimized”, a task with a minimized application window, for example, is only indicated by its task icon in the task bar. Of course, the above enumeration of desktop elements is not complete; rather, there may be further desktop elements enabling the user to interact with different resources in various manners. A data representation of the particular desktop configuration chosen by the user (i.e. a definition of the different desktop elements displayed and their appearance and position, a desktop background etc.) is permanently stored in the computer so that the configuration is maintained when the user logs out, and is restored at the next log-in. In multi-user systems, each user can have a personal configuration, and all user-individual desktop configurations are stored. When a user logs in, his or her personal configuration is restored.

As mentioned above, in some of the embodiments, the virtual desktops are provided by a piece of software called “desktop manager”. A desktop manager is, in some of the embodiments, a part of a computer's operating system kernel, i.e. is running in kernel mode (such as the GUI in Microsoft Windows NT 2000), in other embodiments it is a “standard utility program” running in user mode (such as the GUIs in Linux). In order to display the desktop elements (link icons, mouse cursor, application windows, task bar etc.) and to bestow the required functionality on them, the desktop manager interacts with other parts or components of the operating system. For example, it interacts with a window-management system responsible for the display, management and control of application windows. In some embodiments the desktop manager is a software component separated from other software components, in other embodiments it is combined with other software items, such as the window-management system. The term “desktop manager” is hence a functional term, which does not necessarily imply that a separate software component, solely devoted to desktop management, is provided.

In the embodiments, not only one, but several virtual desktops are available to the user. Typically, only one of these desktops is displayed (hereinafter: the “active desktop”), whereas the other desktops are either not displayed, or are only displayed in a space-saving representation, e.g. in the form of a desktop symbol within a desktop-symbol bar. When required, the user can switch from the currently active desktop to another desktop, thereby making this other desktop visible and disposing of the previously active desktop. The time during which a certain desktop is active (e.g. the time between two switches) is also referred to in this patent as a “desktop session”. The desktop manager is able to handle a plurality of different virtual desktops. In some of the embodiments, switching between desktops may be performed by the user actuating predefined keys or key combinations (“short cuts”), e.g. [Ctrl]+[F1] (wherein “F1” may indicate that a desktop No. 1 is selected) and/or by clicking on the desktop symbol representing the desktop desired. In some of the embodiments, the switching functionality, including the display of the desktop symbols, is assisted by an element of software called a “pager”, which is a part of the desktop manager (although in some of the embodiments with modular software design, a pager may be a separable software component).

As mentioned at the outset, in the prior art plural desktops are used to enlarge the effective screen space for displaying the application windows of the currently active tasks. In such known multi-desktop systems, the users typically group functionally related tasks in the different desktops, for example Web-browser application windows are located in a first desktop, e-mail related application windows in a second one, word-processor-related application windows in a third one, and system-monitoring application windows in a fourth one, etc.

In the embodiments with project-time-tracking functionality, the plural desktops do not only serve to enlarge the effective stream space, but they are also associated with different projects the user works for. Thereby, by working on a particular desktop, the user indicates that he or she is currently working for a particular project, i.e. the project with which the active desktop is associated. Typically, the user is aware of the meaning of the different projects, but from the computers “view” a project is a (meaningless) entity, e.g. identified by a project identifier (or descriptor) which enables it to be distinguished from other projects. For example, a software engineer responsible for developing a new program and maintaining an old program might define two projects, project No. 1 being the project “development”, and project No. 2 the project “maintenance”. He or she might associate desktop No. 1 with project No. 1 and desktop No. 2 with project No. 2, and choose desktop No. 1 when s/he works on project No 1, and desktop No. 2 when s/he works on project No. 2. The computer is arranged to individually track the times spent by the user working on the different desktops. Due to the association between desktops and projects, the times spent on the different projects are thereby individually tracked.

There may be a one-to-one (1:1) relationship between desktops and projects which means that one desktop is associated with each of the projects. Alternatively, there may be a many-to-one (N:1) relationship between desktops and projects, which means that more than one desktop may be associated with a project. For example, if a project can be subdivided into sub-projects, one desktop may be associated with each of the sub-projects. Hence, in N:1 relationships, the time spent with a certain desktop, the “desktop time”, need not necessarily be the “project-time” of the project the desktop is associated with, since other desktops may also contribute to the project time. Therefore, a distinction is sometimes made in this patent between desktop time and project time, for example in the detailed description of embodiments with an N:1 relationship between desktops and projects. On the other hand, in more general contexts in this patent, the term “project-time” is also used with a more generic meaning also covering “desktop time”.

In the embodiments, the recording of the time spent by the user working on the different projects is based on “start” and “stop” events indicative of a commencement or cessation of work. In the simplest manner of project-time recording, the start event is the switch to the desktop assigned to the respective project from another desktop, or the start of the computer (or the user log-in). The stop event may be defined in the same way by the switch from the current desktop to another desktop, or by the shut-down of the computer (or the user log-out). The recorded project times are then simply the time intervals during which the different project-assigned desktops have been active. However, depending on the kind of project-work, such a definition of the start and stop events might result in an insufficiently accurate time measurement. For example, if a user leaves his or her work place, but leaves the computer running, the time of his or her absence is counted as time spent on the project to which the currently active desktop is assigned. Therefore, in other embodiments a start event is defined by the user manually operating a control element indicative of a start of work, or by the user exhibiting user activity on the computer for the first time after the switch or a stop (e.g. by pressing any key on the keyboard, moving the cursor, making a voice input, etc.). Likewise, a stop event can be defined by the user manually operating a control element indicative of a stop of work, or by a failure to exhibit any user activity on the computer for a specified inactivity time (which may, for example, be a predetermined time ranging from some minutes to one hour, depending on the kind of work). In other embodiments, the user is required to regularly confirm that s/he is still working, e.g. by regularly pressing a “dead-man's button” (which may be represented on the computer by a certain key or combination of keys or a clickable graphical button). Not operating the dead-man's button for more than an accepted dead time (e.g. one minute) is a stop event. Since stop events may occur during a desktop session (or the time recording may not be started when a switch to the desktop is performed), the “desktop time” may of course, be shorter than the “desktop session time” (i.e. the time during which the desktop was active).

There are different ways to actually determine the total time spent on the different projects between the start and stop events. In some of the embodiments, the start and stop events are logged (e.g. the nature of an event and its time of occurrence are recorded) for each project-assigned desktop. To obtain project-time statistics, the total time between the start and stop events is calculated for each project, based on the logged data. In other embodiments, the total time elapsed between the start and stop events is individually cumulated for each project-assigned desktop. In the latter embodiments, it is sufficient to store only one number for each desktop, indicating the time already elapsed for the different desktops. For example, if a user generates a start and a stop event in a certain desktop, the time between these events is determined and added to the previously stored cumulated time, which is then replaced by the sum representing the new cumulated time for this desktop. In both embodiments, the logged data representing the start and stop events or the cumulated times are persistently stored, for example in a database or file in the user's computer, or in a centralized database or file accessible via a network to which the users computer is connected.

In some of the embodiments, project-time related statistics data (e.g. the times spent on the different projects) are prepared and/or output at predetermined time intervals, for example daily, weekly, monthly, yearly, etc. In other embodiments, project-time-related statistics data are prepared and/or output on user demand, for example by the user clicking on a project-time-statistics icon. In both cases, a project-time-statistics tool is invoked which aggregates the project-time data (e.g. calculates the project times spent from logged event data) and exports the desired statistics data into files of a desired format or into a database. Formats of files can be spreadsheets, raw structured text (with defined delimiters, such as tabs), HTML reports (by using predefined project-statistics templates), etc. The project-time-statistics tool also enables the user to define whether to continue with the existing project-time data (a report to be prepared is then an intermediate report) or to reset the project-time data (in order to start with a new project or a projects new step). A reset may be individually made for the different projects.

In some of the embodiments, the user is able to configure the multi-desktop-and-project-time-tracking system by means of a configuration tool. For example, the configuration tool enables the user to define the association of one or more desktops to a particular project; (normally project-related) desktop names; the time-tracking type (e.g. logging individual start and stop events or storing cumulated project-ime data); the way in which start and stop events are generated; the way and format in which project-time statistics data are to be generated and presented (e.g. regularly and/or on a user request), as well as additional attributes, for example priority data, etc.

As already mentioned above, in some of the embodiments the user is able to define, as individual desktop settings, the link icons individually for the virtual desktops. Hence, upon switching from one of the desktops to another, different link icons are displayable. In some of these embodiments, in addition to the link icons, the user is also able to determine further desktop settings individually for the virtual desktops. These further desktop settings are, for example, resources (such as assigned hardware devices), positions of the link icons within the desktop, shortcuts, background pictures etc. Hence, upon switching from one of the desktops to another, different further desktop settings become active.

In these embodiments, the user can therefore not only assign the different desktops to different projects to track the time spent on them, but also individually adapt the desktops to the different projects. For example, typically each project requires different applications, data files, web sites, resources, short-cuts, etc. By virtue of the ability to define link icons (and, optionally, further desktop settings), the user may specifically define for each desktop those link icons (and further desktop settings) which pertain to the project to which the respective desktop is assigned, thereby creating a project-time-tracking system based on project-specific desktops (however, as mentioned above, it should be noted that in some embodiments the functionality of individually definable link icons (and further desktop settings) is realized without project-time-tracking functionality, in other embodiments the two functionalities are combined).

In embodiments with individually definable link icons, upon a switch from one virtual desktop to another, the desktop settings of the old desktop (i.e. the desktop active up to the switch) are stored, the desktop settings of the newly selected desktop (also called “the new desktop”) are retrieved, and the retrieved desktop settings are used as the desktop settings for the new desktop.

The way this is implemented in practice may depend on the operating system used in the computer (it is noted that the term “operating system” is often used in a strict sense meaning that portion of the software that runs in kernel mode (see, for example, A. Tanenbaum: Modern Operating Systems, 2^{nd} edition, 2001, pp. 1-3)). Herein, the term “operating system” is used in a broader sense including software that is typically sold together as “operating system”; it hence includes software, such as a graphical user interface, which may run not in kernel mode, but rather in user mode.

In current Microsoft Windows (MS) operating systems (e.g. Windows 95/98 or NT 2000) the information about desktop elements is stored in two different locations: data representing what desktop elements are to be placed on the desktop is stored in a desktop directory, and data representing where each element is to be placed is stored in the registry. Current MS Windows operating systems provide only one virtual desktop. The embodiments which are extensions to those single-desktop operating systems therefore extend the single-desktop manager's functionality to a multi-desktop functionality which enables the user to switch between several desktops having individual desktop settings. Upon receipt of a switch event, the desktop settings of the old desktop are exported from the desktop directory and the registry and are stored at another place, e.g. an individual-desktop-settings database, and the desktop settings of the new desktop are imported therefrom into the desktop dirertory and the registry. Application windows of tasks associated with the old desktop are minimized, and may even be removed from the task bar, and application windows of tasks associated with the new desktop are resized (or maximized) and displayed in the task bar. Thereby, tasks associated with non-active desktops keep on running in the background, and their application windows are only minimized and resized. Based on the switch events, and, optionally, on other start and stop events, the multi-desktop-and-project-Ume-tracking extension also implements the project-time-tracking functionality, as described above.

Other embodiments are extensions to operating systems having desktop maragers able to switch between several desktops “out of the box”, such as Unix or Unix derivate operating systems, including Linux (called “Unix/Linux” hereinafter). Such desktop managers, for example, are KDE, GNOME, and CDE. In these available systems, all desktops of a user use the same desktop settings. Each of these systems stores the desktop settings in different locations and formats. In embodiments of the extension with desktops which can be individualized, the desktop settings are retrieved, stored and set, either directly, or by an API (Application Program Interface). The extension subscribes at the desktop manager to receive desktop-switch events. The available Unix/Linux systems have different mechanisms for handling events: KDE's mechanism is based on Trolitech's GUI class library; GNOME provides its own class library; and CDE is mostly based on X11 events. Irrespective of these differences, in some of the embodiments, the extension: (i) subscribes to receive desktop switch events; (ii) upon receipt of a switch event, stores the desktop settings of the old desktop; (iii) retrieves the stored desktop settings of the new desktop; (iv) assigns project-time information to the respective desktops, e.g. a cessation of work to the old desktop and a commencement of work to the new desktop.

The embodiments of the computer program product with program code for performing the described methods include any machine-readable medium that is capable of storing or encoding the program code. The term “machine-readable medium” shall accordingly be taken to include, but not to be limited to, solid state memories, optical and magnetic storage media, and carrier wave signals. The program code may be machine code or another code which can be converted into machine code, such as source code in a multi-purpose programming language, e.g. C or C++. The embodiments of a computer include commercially available general-purpose computers programmed with the program code.

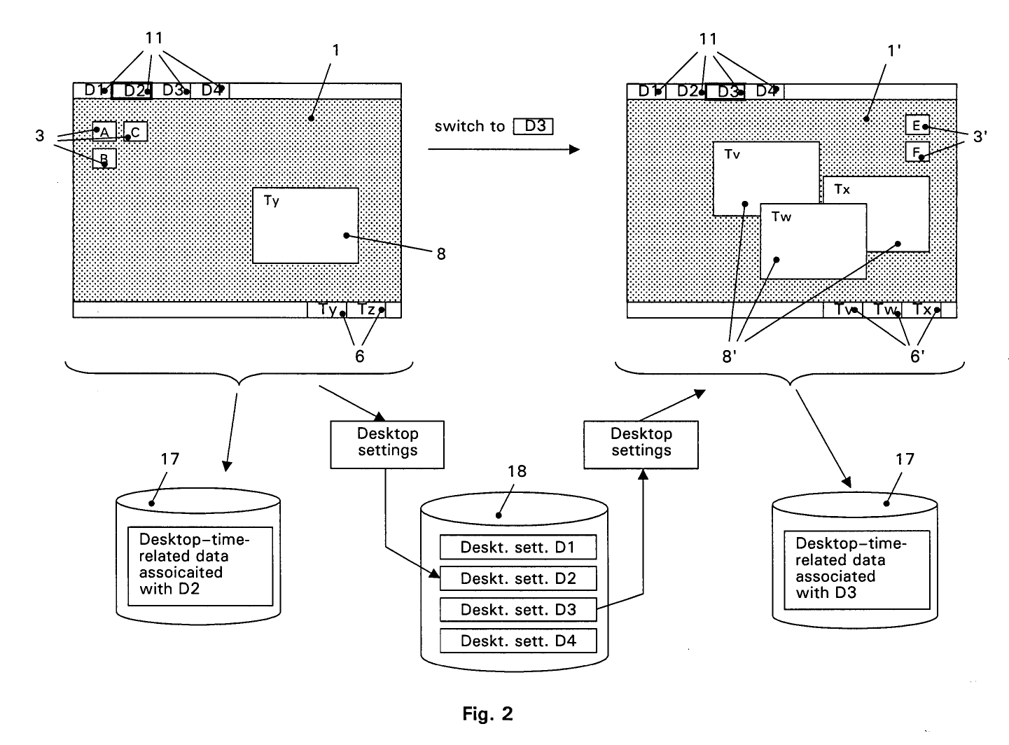

Returning now to FIG. 1, it illustrates a GUI with an exemplary virtual desktop 1. The desktop 1 has a desktop background 2, for example a blank screen, a regular pattern or a background picture, also called “wallpaper”. Different desktop elements are placed on the background 2, for example link icons 3, a popup menu 4, and a control panel 5 with control icons. Active applications are represented by task icons 6 in a task bar 7. A mouse cursor 9 is a further desktop element; its movement on the desktop 1 represents movements of a pointing device, such as a mouse or a track-ball. There may also be invisible (i.e. purely logical) desktop elements, such as short-cuts (certain combinations of keys) which may, for example, start a task or trigger another activity. The user is able to define and alter the desktop elements, their functions, locations, shapes, and sizes. Furthermore, an application window 8 may be open for some or all of the active applications; it represents an output/input interface to the application it is associated with. Although task icons 6 and application windows 8 are automatically created and deleted when a task is started or stopped, at least the size, shape and location of the application windows in the desktop 1 can be modified by the user. The desktop elements can be defined and configured individually for different virtual desktops as will be illustrated in connection with FIG. 2. Since different tasks are associated with the desktops in which they are started, and only these tasks are displayed in the associated desktop, the presence of task icons 6 and application windows 8 is also desktop-individual.

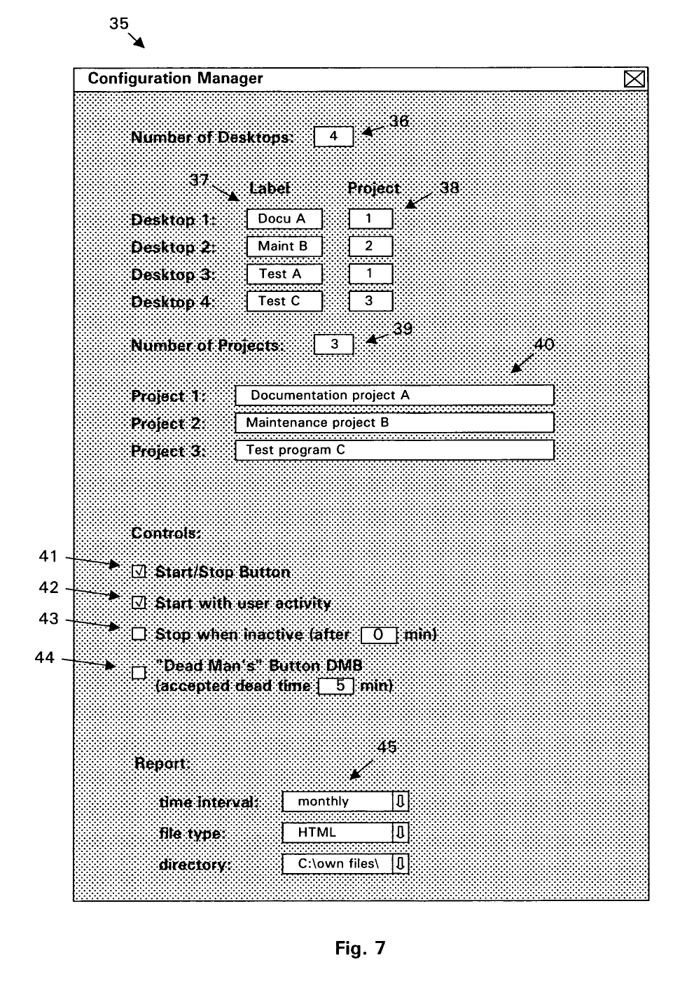

The GUI of FIG. 1 also shows multi-desktop-and-project-time control elements, e.g. grouped in a control bar 10. Strictly speaking, the control bar 10 does not form a part of the desktop 1, since it serves to control the different virtual desktops and is therefore a kind of “meta-control” element, largely or completely invariant under 7 desktop switches. It has two groups of controls, e.g. in the form of graphical buttons. The first group includes desktop-switch controls 11, e.g. in the form of graphical buttons. By clicking with the cursor 9 on one of the desktop-switch buttons 11, the user can initiate a switch to the clicked desktop. The currently displayed (i.e. active) desktop is indicated in the control bar 10, e.g. by highlighting the desktop-switch button 11 which represents the currently displayed desktop (which is, for example, desktop D2 in FIG. 1). The second group includes project-time-tracking controls. A start button 12 and a stop button 13 enable the user to indicate a commencement or cessation of work. By clicking on a dead man's button 14 the user can show that he or she is still present (in other embodiments, the dead man's button is realized by a shortcut which can be actuated more easily than a graphical button). A project-time-statistics button 15 enables the user to initiate an evaluation and output of project-time-related statistics. A project-time-configuration button 16 gives the user access to a project-time-configuration page (see FIG. 7 below). The control bar 10 also provides an indication of whether the time currently elapsing is counted as work time or as pause time, e.g. by highlighting the start or stop button, or by a separate indicator element (in the example of FIG. 1, the start button 12 is highlighted indicating that the current time is counted as work time).

In other embodiments, the project-time-related control elements 12-16, or some of them, are not meta-control elements, but are configurable in a desktop-individual way. For example, in some of the desktops, start and stop buttons may be useful, whereas in other desktops no such buttons are displayed. Likewise, in some desktops, no user-feedback is required, so that the dead man's button is omitted; other desktops requiring user-feedback provide such a button.

FIG. 2 illustrates a switch from one desktop 1 (“D2” in the example of FIG. 2) to another desktop 1′ (“D3” in FIG. 2). Desktop 1 displays certain desktop-individual link icons 3 (“A”, “B”, and “C” in FIG. 2). Two tasks, “Tx” and “Ty”, are active in the desktop 1 and are indicated by corresponding task icons 6. For one of these tasks, Ty, an application window 8 is displayed in the desktop 1. The different desktop elements, such as the link icons 3, as well as the size and position of application windows 8 are individually defined and configured for each desktop.

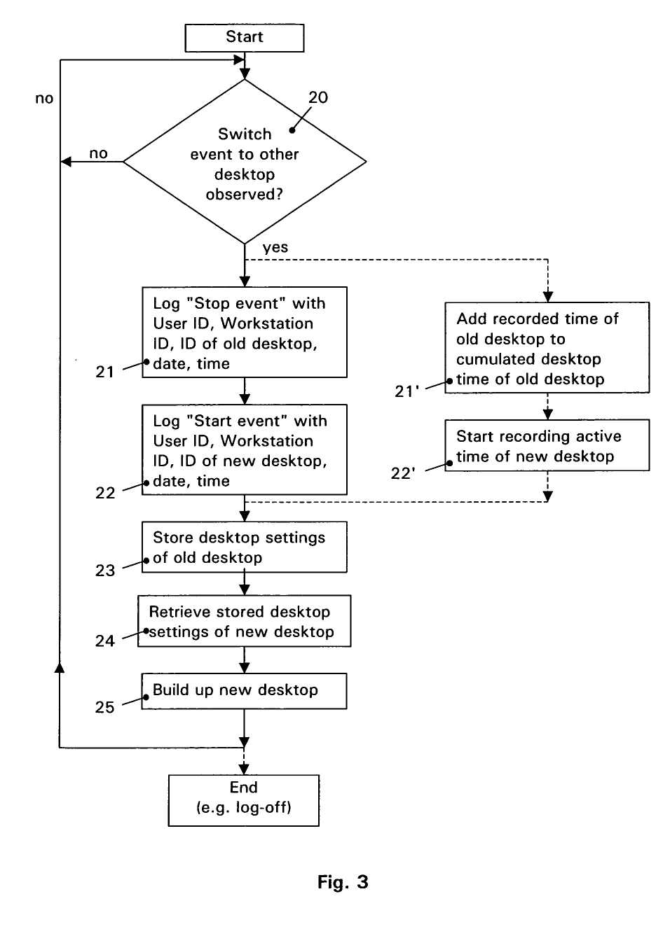

Data indicative of the time spent by the user in the currently active desktop 1 is stored in a manner associated with the current desktop 1. This is symbolized in FIG. 2 by desktop-time-related data which is associated with D2, and are stored in a desktop-time database 17. Several alternatives of how desktop-time or project-time data may be recorded are described below in FIGS. 3-6.

When the user initiates a switch-over to another desktop 1′, for example by clicking on a desktop-switch button 11 representing a currently inactive desktop (in FIG. 2; D3″), the desktop settings of the old desktop 1 (D2) are persistently stored in an individual-desktop-settings database 18, and the (previously stored) desktop settings of the new desktop 1′ (D3) are retrieved therefrom and are used, instead of the old settings, to build up the new desktop 1′. This storage and retrieval of the desktop individual settings is also illustrated in FIG. 2. Similarly, data representing the task icons 6, the application windows 8 as well as application windows settings, such as the position, size and shape of the application windows, are also stored for each desktop, for example in a dedicated application-windows database. As can be seen in the example of FIG. 2, different link icons 3′ (“E” and “F”) are displayed at different locations in the new desktop 1′. Similarly, different task icons 6 and application windows 8 are displayed in the new desktop 1′.

Since now the new desktop 1′ is active, data indicative of time spent are now recorded in a manner associated with the new desktop 1′ in the desktop-time database 17.

FIG. 3 is a flow diagram illustrating the desktop switching and project-time-tracking-process carried out in the computer. FIG. 3 shows an embodiment in which the project-time recording is started and stopped by the user switching from one to another desktop. It is assumed that, when the process shown in FIG. 3 begins, a certain desktop is already active (for example, when the user starts or logs in to the computer, the desktop which was active before the last shutdown or, in a multi-user system, before the last log-out of this user, will be activated again). At 20, it is ascertained whether a switch event to another desktop has occurred. For example, a switch event may be the user clicking on a desktop-switch button or inputting a desktop-switch shortcut referring to a currently inactive desktop. If the answer is negative, the observation performed at 20 is continued, but no further activity is performed. However, if a switch event is observed, a group of project-time-tracking activities (21 and 22) and a group of desktop-switch activities (23, 24 and 25) are performed. At 21, a “stop” event is logged, for example together with a user identification (ID) identifying the currently logged-in user, a workstation ID identifying the currently used workstation, an ID of the old desktop used up to now, and data representing the current date and time. At 22, a “start event” is logged, for example, with the user ID, the workstation ID, the ID of the new desktop, date and time. In other embodiments, only a “switch event” is logged instead of the stop and start events in 21 and 22. The switch event may indicate the IDs of both the old and the new desktop (in principle, it is even sufficient to log only one of the IDs, for example only the ID of the new desktop, since the previously logged switch event contains the ID of the old desktop). At 23, the desktop settings of the old desktop are stored. At 24, previously stored desktop settings of the new desktop are retrieved. At 25, the new desktop is built up in the graphical user interface, based on the retrieved desktop settings. Then, the process continues with the switch-event observation at 20. A shut-down or log-out causes a “stop event” to be logged, and a start of the computer or log-on causes a “start event” to be logged.

An alternative embodiment with regard to how the project-time is recorded is also displayed in FIG. 3, by dashed lines. This embodiment is not based on logging events from which the project-time may later be calculated, but uses cumulative time counting. For example, a timer is provided which is reset and started when a desktop is activated; hence, its contents represents the time elapsed since the desktop has been activated. Cumulated active-desktop times are persistently stored for all desktops in a desktop-time database. At 21′, the contents of the timer, i.e. the time the old desktop has been active since its last activation, is added to the cumulated desktop-time of the old desktop, and the previously stored cumulated value is overwritten by this sum. At 22′, the recording of the active time of the new desktop is started by resetting the timer. When the computer is started or the user logs in, only the activity 22′ is carried out. There are several variants of the cumulated desktop-time recording. For example, rather than resetting the timer upon activation of a desktop, the timer may start with the desktop time already cumulated for this desktop. If a switch away from this desktop occurs, the contents of the timer already represents the cumulated time; hence, its contents may simply be stored for this desktop (by overwriting the previously stored desktop time for this desktop). In a still further alternative embodiment, the cumulated desktop time stored in the desktop-time database is permanently incremented for the currently active desktop, e.g. every minute. Upon switching from one desktop to another no further storing activity is required since the stored cumulated desktop times are already up to date.

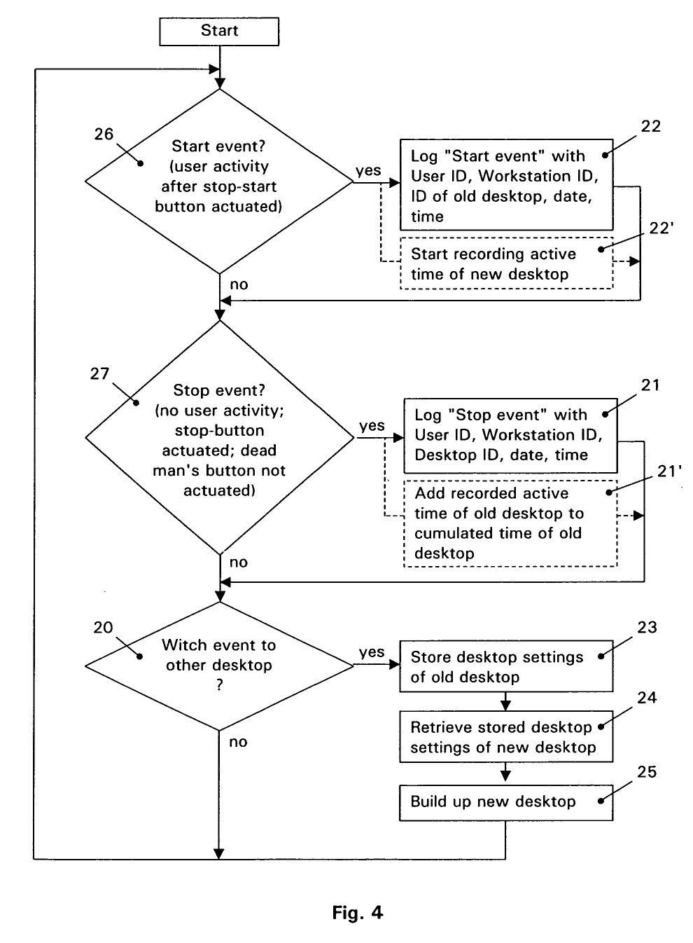

FIG. 4 is a flow diagram similar to FIG. 3 of another embodiment in which the project-time recording can be started and stopped independently of a desktop switch. In the embodiment of FIG. 4, it is not only ascertained at 20, whether a switch event has occurred, but also, at 26 and 27, whether a start event or a stop event has occurred. A start event, for example, may be the user showing activity after a stop, or actuating the start button. A stop event may be a failure to exhibit any user activity for a specified inactivity time, an actuation of the stop button by the user, or a failure to press the “deadman's button” for more than the accepted dead time. If a start event is observed, it is logged at 22, or the recording of the active time of the new desktop is started at 22′, as explained above in connection with FIG. 3. If a stop event is observed, it is logged at 21, or the recorded active time of the old desktop is added to the cumulated time of the old desktop at 21′, as explained above in connection with FIG. 3. If a switch event is observed, the group of desktop switch activities 23, 24 and 25, as explained above in connection with FIG. 3, is performed. The independence of start and stop events from desktop switch events according to FIG. 4 enables times in which the user is inactive, or does not want to have the time recorded for other reasons, to be excluded from the project-time recording. Of course, in embodiments rep resented by FIG. 4, switch events may also form start and/or stop events. For example, even if a user is able to expressly start and stop project-time recording, it may be assumed that switching to a new desktop implies that the project-time recording ought to be immediately started for the new desktop; the switch event is then also considered as a start event for time recording in the new desktop (and, optionally, as a stop event for time recording in the old desktop, if the project-time recording was active). By contrast, in other embodiments, the user may be required to expressly start the project-time recording after a desktop switch; in such embodiments, a switch to a new desktop may automatically stop the time-recording (if it was active in the old desktop); a switch event is then also considered as a stop event for the time recording in the old desktop.

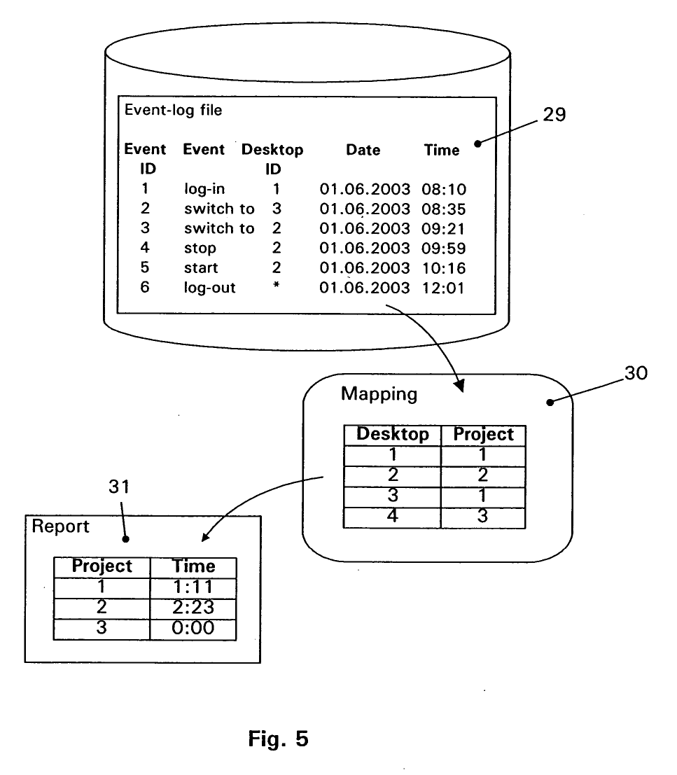

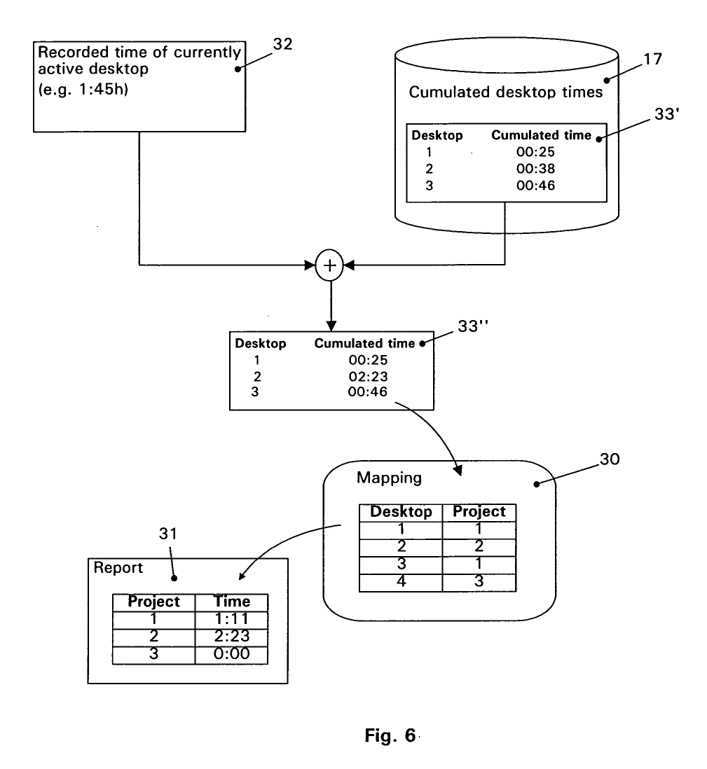

FIGS. 5 and 6 illustrate the two different ways of project-time tracking (which have already been mentioned above in FIGS. 3 and 4) in more detail.

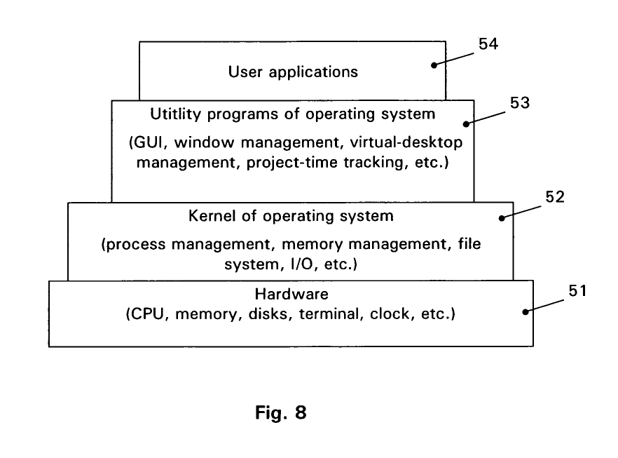

According to the embodiment illustrated in FIG. 5, upon appearance of an event, such as a switch event, a start or stop event, or a log-in or log-out event, a record is written in the desktop-time database, which is here, for example, in the form of an event-log file 29. Each record may indicate the event type, the ID of the active desktop, and the date and time of the event. In the embodiment shown in FIG. 5, five different event types are logged; log-in, log-out, switch to, start, and stop. Although a “switch to” event implies a stop of the time recording in the desktop active up to the switch and a start of the time recording in the desktop active after the switch, these “implied events” are not expressly logged in FIG. 5. Similarly, although a log-in implies a start of the desktop-time recording (e.g. in a default desktop, or the desktop which was used by the present user the last time) and a logs-out implies a stop of the time recording, the corresponding start and stop events are not expressly logged. Rather, in FIG. 8, only start and stop events which appear within a desktop session are recorded (e.g. starts and stops triggered by the user actuating the start or stop button). In other embodiments, such “implied” start and stop events are also logged, to introduce some redundancy.

In regular intervals, or when the user actively requests a report on the time spent by him or her on the different projects (e.g. by clicking on the statistics button 15 in FIG. 1), a report is prepared by the multi-desktop-and-project-time-tracking system. Using the events in the log file 29, the times during which the different desktops were active, excluding those time intervals when the time recording during a desktop session was stopped, is individually calculated for the different desktops. In the example of FIG. 1, for desktop “1” a desktop time of 0:25 h between the “log-in” and the “switch/to/desktop 3” is obtained, for desktop “2” a desktop time of 2:23 h between the “switch/to/desktop 2” and the “stop 2” and between the “start 2” and the “log-out” is obtained, and for desktop “3” a desktop time of 0:46 h between the “switch-to desktop 3” and the “switch/to/desktop 2” event is obtained. In embodiments with a 1:1 relationship between desktops and projects the desktop times obtained in this way already represent the project times of the projects to which the desktops are assigned (in the simplest case, the desktop numbers correspond to project numbers, so that the report could simply state the desktop number/project number and the corresponding desktop/project time; in other embodiments, different project identifiers may be mapped to the desktops and included in the report). In the more general case of a N:1 relationship a corresponding mapping 30 between desktops and projects is provided. In the example of FIG. 5, two desktops (desktops “1” and “3”) are mapped to one and the same project (project “1”). Based on the mapping 30, the desktop times (calculated as described above for 1:1 relationships) assigned to the same project are added. Correspondingly, the exemplary project-time report 31 in FIG. 5 states that the time spent on project “1” is 1:11 h, on project “2” 2:23 h, and on project “3” 0:00 h.

In other embodiments, the N:1 mapping is already applied when the events are written to the log file; the data records then include a project ID. The project times are then obtained by adding the time intervals between switch events and start/stop events individually for each project ID taking into account the mapping from desktop to projects, analogously to what has been explained above for desktop times in the case of a 1:1 relationship.

According to the other embodiment illustrated in FIG. 6, the project-time tracking is based on cumulating project or desktop times. In the embodiment of FIG. 6, the time elapsing in an active desktop from switching to this desktop, or starting the time recording in this desktop, to switching to another desktop, or stopping the time recording; is recorded by a timer 32. For example, exemplary FIG. 6 illustrates the point of time immediately before the log-out in FIG. 5; the desktop time recorded in 32 therefore refers to desktop 2, and the recorded time is 1.45 h. Cumulated desktop times for each desktop are stored in the desktop-times database 17, here, for example, in the form of a table. In FIG. 6, an exemplary snapshot representing the table's state immediately before the log-out of FIG. 5 is shown at 33′. It includes the cumulated desktop times of all desktops up to “start 2” of FIG. 5; the current desktop session in desktop “2”, lasting from “start 2” to the log-out is not yet included in the cumulated-desktop-times table. At the end of the current desktop session, i.e. upon the log-out in FIG. 5, the desktop time recorded in 32 is added to the data record of the cumulated desktop-times table referring to the current desktop, i.e. to desktop “2”. The resulting snapshot of the table is shown at 33″ in FIG. 6. In the case of an 1:1 relationship, the cumulated times contained in the cumulated-desktop-times table already represent the project times, and can immediately be output in a project-time report. In the case of an N:1 relationship, the cumulated desktop times are mapped to project times, by mappings 30, as described in connection with FIG. 5. Finally, a project-time report 31 is prepared, as in FIG. 5.

In other embodiments of the cumulated-project-time recording similar to FIG. 6, the timer 32 is not reset upon a switch or start event, but the timer 32 is started with already cumulated desktop time for the current desktop read in from the table in the state 33′, and is increased as time elapses during the current desktop session. When the session is terminated, the time recorded then by the timer 32 is written back to the cumulated-desktop-times table, which then results in a snapshot as 33″. In still another embodiment, instead of using a timer, the table's record pertaining to the presently active desktop is constantly updated, e.g. incremented every minute. In all three cases, at the end of the session (i.e. when the log-out happens), the snapshot 33″ is obtained.

FIG. 7 shows an exemplary interface 35 of a configurator of the multi-desktop-and-project-time-tracking system which may be activated by the user, e.g. by clicking on configuration button 16 in FIG. 1. The configurator enables the user to define the settings of the project-time-recording system described so far. Upon starting the configurator, the graphical configuration interface 35 is displayed in an application window. The user can specify the total number of virtual desktops in an edit box 36 and the total number of projects in an edit box 39. For each desktop, the user can specify a desktop label and the ID of the project to which the desktop is assigned, in edit boxes 37 and 38. A text description of each project can be entered at 40. Several controls for the definition of start and stop events are provided, for example a control 41 for activating the start/stop buttons, a control 42 by which the user can define that time recording is to be started with user activity, a control 43 by which the user can define that the time tracking is stopped in the case of inactivity for a user-definable time period, and control 44 by which the dead-man's button functionality can be activated and the accepted dead time be defined. Finally, by means of pull-down menus 45, the user can choose a period after which project-time reports are automatically generated, the file type of the reports and the location where they are stored.

FIG. 8 is a diagrammatic representation of layers of a computer including multi-desktop-and-project-time tracking software for an exemplary Unix/Linux system. The lowest layer is a hardware layer 51 including a CPU, memory, disks, a terminal, a clock, etc. The other layers are software layers; the lowest software layer is the kernel 52 of the operating system. It is responsible for process management, memory management, the file system, input/output, etc. and runs in kernel mode. On top of the kernel 52 is a layer 53 including utility programs of the operating system, including the GUI, the window management system, the virtual-desktop management which enables the user to switch between different desktops with individually definable link icons, the project-time tracking system, etc. On top of the utility programs layer 53 are user applications 54. The utility programs 53 and the user applications 54 run in user mode. In other operating systems, for example Windows operating systems, a number of the utility programs also run in kernel mode, and hence belong to the kernel. In some of these embodiments, the virtual-desktop-and-project-time tracking system also belongs to the kernel, it may then be an integrated part of the Windows operating system. In other embodiments, however, the entire or a part of the multi-desktop-and-project-time tracking system runs in user mode, for example when it is an extension to current Windows operating systems.

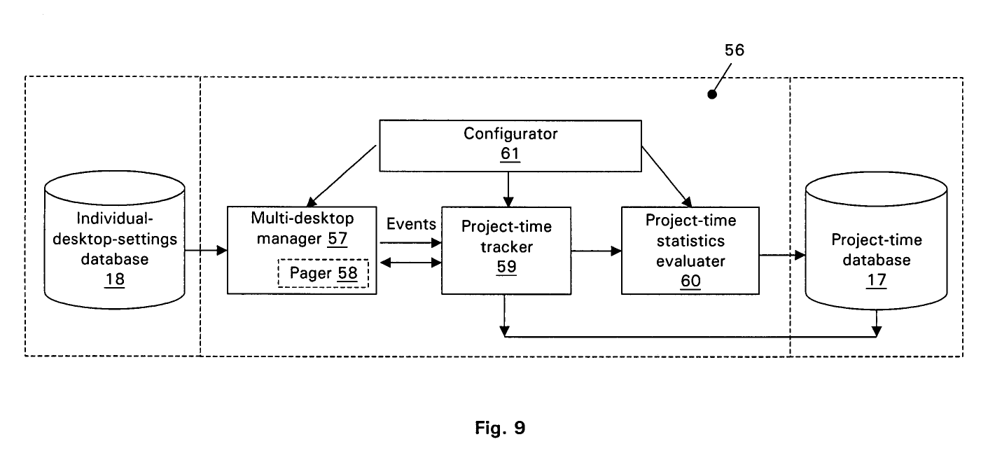

FIG. 9 is a high-level architecture diagram of a multi-desktop-and-project-time-tracking system 56. It includes a multi-desktop manager 57 with a pager 58, a project-time tracker 59, a project-time statistics evaluator 60, a configurator 61 as well as databases 18, 17 for storing individual-desktop settings data and project-time data. The multi-desktop manager 57 provides the desktop-switch functionality described above. The pager 58 displays the desktop-switch buttons 11 of FIG. 1 and, upon actuation of one of them, causes the multi-desktop manager 57 to perform the requested desktop switch. In order to provide the different desktops with individually-definable link icons, and other desktop settings, the multi-desktop manager 57 stores the desktop settings of the old desktops in, and retrieves the ones of the new desktop from, the individual-desktop-settings database 18. The multi-desktop manager 57 is also responsible for providing the other controls of the multi-desktop-and-project-time-control bar 10 of FIG. 1, for example the start and stop buttons 12, 13, the dead-man's button 14, the project-time statistics button 15 and the project-time configuration button 16 of FIG. 1, based on specifications by the configurator 61 (which, in turn, may be entered by the user by means of the configurator's interface shown in FIG. 7). If an event relevant for project-time tracking occurs (be it a switch event, or another event indicative of a start or stop of work, such as an actuation of the start and stop buttons, exhibiting user activity after a stop, or failure to exhibit such an activity for a specified time, not operating the dead-man's button, etc.), the multi-desktop manager 57 notifies the project-time tracker 59 of the event. For example, the project-time tracker 59 may be subscribed at the multi-desktop manager 57 to receive such events; if an event occurs, the multi-desktop manager 57 then actively notifies the project-time tracker 59. In alternative embodiments, the project-time tracker 69 regularly sends notification requests to the multi-desktop manager 57, and if an event has occurred since the last notification request, the multi-desktop manager 57 returns the requested event notification to the project-time tracker 59.

The project-time tracker 59 provides the project-time-tracking functionality described above. On the basis of event notifications, and information received from the multi-desktop manager 57 (i.e. information identifying the currently active desktop and/or the desktop from which or to which a switch is carried out), the project-timer tracker stores event-representing data in the desktop-time database 17, or increases cumulated desktop-time counters in the desktop-time database 17, as described in connection with FIGS. 5 and 6.

The project-time statistics evaluator 60 prepares project-time reports 31 based on data in the project-time database 17, as described in connection with FIGS. 5 and 6. The reports are prepared on user request (the user may, for example, actuate the statistics button 15 (FIG. 1)), or on a regular basis.

The configurator 61 provides the graphical configuration interface 35 (FIG. 7) to the user and configures the multi-desktop manager 57 with the pager 58, the project-time tracker 59 and the project-time statistics evaluator 60 in accordance with the settings of the project-time-recording system defined by the user via the configuration interface 35.

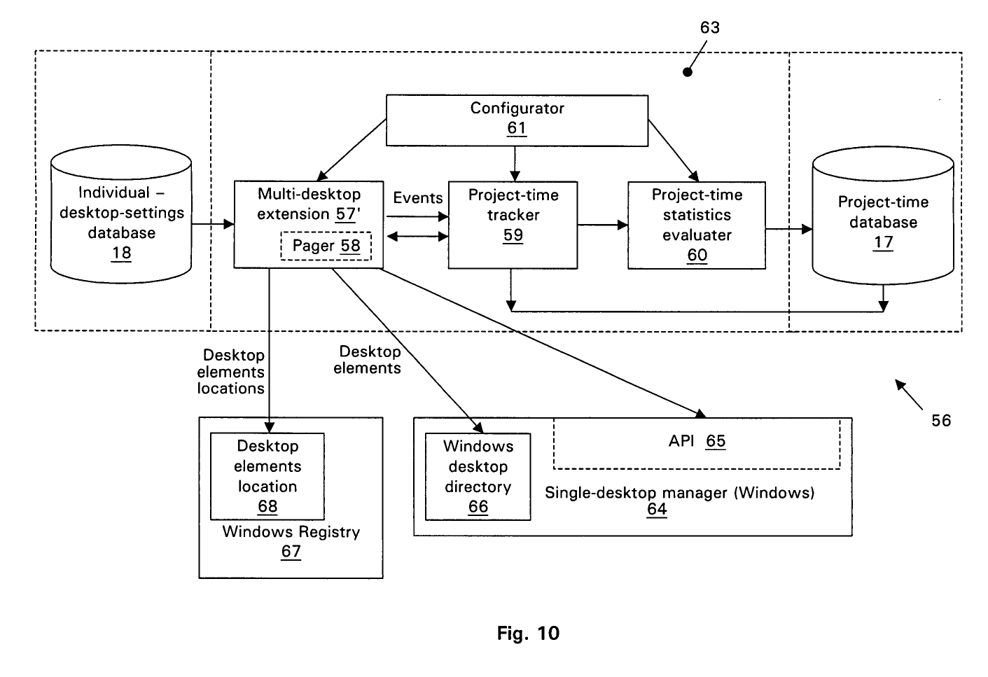

FIG. 10 is an architecture diagram similar to FIG. 9 illustrating an embodiment in which the multi-desktop-and-project-time-tracking system 56 is formed by an extension 63 to a MS Windows operating system. In FIG. 10, only the relevant parts of the MS Windows operating system are reproduced, i.e. the usual single-desktop manager 64 including an API 65 and a Windows desktop directory 66, as well as a part of the Windows registry 67.

The switching between two desktops is performed by minimizing all open application windows, storing representations of the desktop elements of the old desktop and removing the desktop elements from the GUI, retrieving desktop-elements representations of the new desktop and displaying the retrieved elements in the GUI, and eventually maximizing application windows of tasks associated with the new desktop. Thereby, tasks associated with non-active desktops keep on running in the background, and their application windows are only minimized and resized.

In MS Windows, data representing the desktop elements of the (single) desktop are stored in the desktop directory 66. Data representing the positions of the desktop elements are stored at 68 within the Windows registry 67 at 68. In order to provide the multi-desktop manager functionality described in connection with FIG. 9, a multi-desktop extension 57′ with a pager 58 is provided. It is similar to the multi-desktop manager 57 and pager 58 of FIG. 9, but uses the functionality of the single-desktop manager 64 already provided by the MS Windows operating system. In order to perform a desktop switch, it retrieves the data representing the desktop elements, and their positions, of the old desktop from the desktop directory 66 and the Windows registry 67, stores them in the individual-desktop-settings database 18, and then retrieves the corresponding data for the new desktop from the individual desktop settings database 18 and stores them in the desktop directory 66 and the registry 67 at 68. Application windows associated with the old desktop are minimized (and may also be removed from the task bar), and application windows associated with the new desktop are resized (and may now also be iconized in the task bar). As a consequence, the desktop elements, application windows and task icons of the old desktop disappear from the GUI and their functionality is inactivated, whereas the ones of the new desktop are displayed in the GUI, and their functionality is activated. This represents a virtual-desktop switch for the user. Some of the functions of the project-time-tracking extension 56 are based on functions provided by the MS Windows operating system. For example, the multi-desktop-and-project-time-control bar 10 (FIG. 1) is implemented via the API 65, and the operating system notifies the multi-desktop extension 57′ via the API 65 if a control of the control bar 10 is actuated. Concerning further features and functions, the multi-desktop-and-project-time-tracking extension 63 is similar to the system 56 described in connection with FIG. 9, so that reference is made to the description of FIG. 9 above.

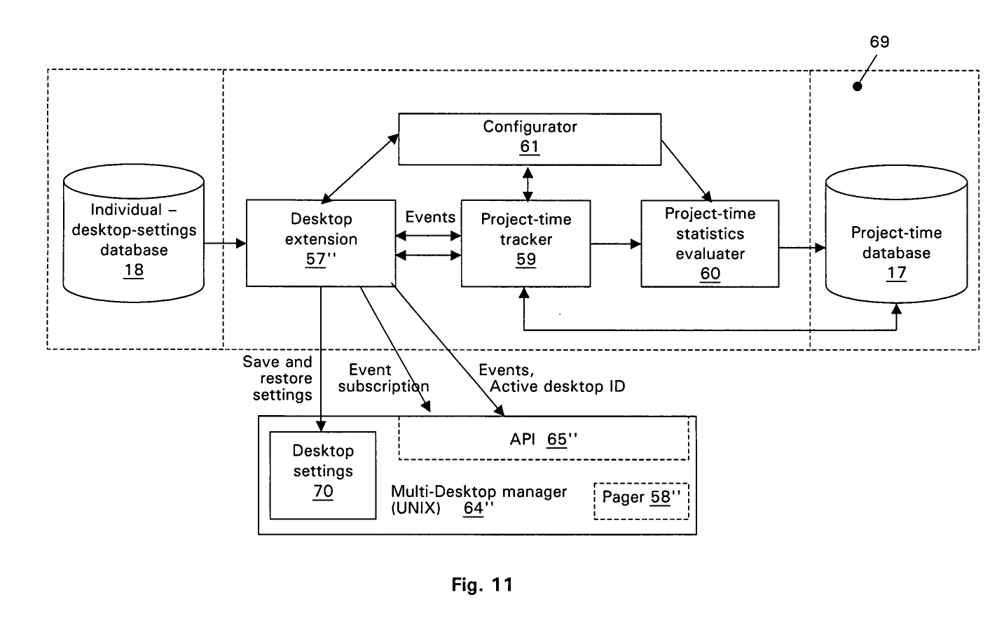

FIG. 11 is an architecture diagram similar to FIG. 10 illustrating another embodiment in which the virtual-desktop-and-project-time-tracking system 56 is mainly formed by an extension 69 to a Unix/Linux operating system. Current Unix/Linux-based GUIs, such as KDE, GNOME, CDE, already provide a multi-desktop function ality. Consequently, the relevant part of the operating system reproduced in FIG. 11 is a multi-desktop manager 64″, including a pager 58″, an API 65″, and a desktop-settings database 70. Although the Unix/Linux operating systems provide a multi-desktop functionality, the desktop settings stored at 70 are the same for all desktops of one and the same user. Hence, the different desktops differ only with regard to tasks and application windows, but display the same link icons and other desktop elements. (Since Unix/Linux are multi-user operating systems, another user may have different desktop settings. However, to display the different desktop, the other user has to log in to the computer. Herein, activation of a different desktop due to a log-in, log-out, or switch to another user, is not considered a “desktop switch”).

The project-time tracking extension 69 uses the multi-desktop functionality of the Unix/Linux operating systems. A desktop extension 57′ enables individual desktop elements to be displayed upon a desktop switch, by storing the desktop settings of the old desktop stored at 70 in the individual-desktop-settings database 18, retries ing the desktop settings of the new desktop from the database 18 and storing them at 70, either directly or via the API 65″. The desktop extension 57″ is subscribed at the multi-desktop manager 64″ to receive desktop-switch events as well as other events relevant to project-time tracking, such as start and stop events, e.g. triggered by an actuation of the start or stop button 12, 13 (FIG. 1). When such an event occurs, e.g. when the user switches to another desktop by means of the pager 58″, the API 65″ notifies the desktop extension 57″ of the event. In some of the embodiments, the multi desktop manager 64″ also informs the desktop extension 57″ which one of the desktops is currently active (in other embodiments this may be omitted since the switch event carries sufficient information). Concerning further features and functions, the project-time-tracking extension 56 is similar to the system described in connection with FIGS. 9 and 10, so that reference is made to the description of FIGS. 9 and 10 above.

The hardware 51 shown in FIG. 8 may include primary storage, such as a main memory, a static memory and/or a volatile memory. It may further include secondary storage, such as magnetic and/or optic disk storage devices. The software embodying the multi-desktop-and-project-time-tracking system 56 (FIG. 9) or the corresponding extensions 63 and 69 (FIGS. 10 and 11), or any other of the methodologies described above, is a set of instructions residing, completely, or at least partially, within the first and/or second storages. The software may further be transmitted or received via a network interface of the computer in the form of carrier wave signals.

All publications and existing systems mentioned in this specification are herein incorporated by reference.

Although certain methods and products constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

1. A memory storing computer program including program code, when executed on a computer, for tracking the time spent by a user working with the computer for different projects, the program code being arranged to:
provide a plurality of virtual desktops which are assignable to different projects and switchable by the user;
track the time spent by the user working on the different desktops, thereby tracking the time spent on the projects to which the respective desktops are assigned.

2. The memory of claim 1, wherein the program code is arranged to track the time spent by the user working on the different project-assigned desktops based on “start” and “stop” events indicative of a commencement or cessation of work.

3. The memory of claim 2, wherein a start event is at least one of:
switching to the desktop assigned to the respective project;
manually operating a control element indicative of a start of work;
exhibiting user activity on the computer after a stop; and
starting the computer or logging-in.

4. The memory of claim 2, wherein a stop event is at least one of:
switching from the current desktop to another desktop;
manually operating a control element indicative of a stop of work;
failure to exhibit any user activity on the computer for a specified inactivity time;
not confirming an invitation to confirm user activity;
not operating a dead-man's button for more than an accepted dead time;
shutting down the computer or logging-off.

5. The memory of claim 2, wherein the program code is arranged to track the time spent by the user working on the different project-assigned desktops by logging, for each project-assigned desktop, the start and stop events, and by finally calculating the total time between start and stop events.

6. The memory of claim 2, wherein the program code is arranged to track the time spent by the user working on the different project-assigned desktops by cumulating, for each project-assigned desktop, the time elapsed between the start and stop events.

7. The memory of claim 1, wherein the program code is arranged to prepare project-time-related output data in predetermined time intervals or on user demand.

8. The memory of claim 1, wherein the program code is arranged such that the virtual desktops present link icons, and is arranged to enable the user to define, as individual desktop settings, the link icons individually for the different project-assigned desktops, so that, upon switching from one of the desktops to another, different link icons are displayable.

9. The memory of claim 8, wherein the program code is arranged to enable the user to determine further desktop settings, besides the link icons, individually for the virtual desktops, said further settings being at least one of: resources, positions of the link icons, and background pictures, so that, upon switching from one of the desktops to another, different desktop settings are active.

10. The memory of claim 8, wherein the program code is arranged, upon a switch from one virtual desktop to another, to:
store the desktop settings of the old desktop;
retrieve the desktop settings of the newly selected desktop;
use the retrieved desktop settings as current desktop settings for the newly selected desktop.

11. The memory of claim 10, wherein the program code is arranged to be executed in the framework of a Microsoft Windows operating system comprising a desktop manager using a desktop directory and a registry, wherein the desktop settings are located in the desktop directory and in the registry, and wherein the program code is arranged, upon a switch from one virtual desktop to another, to export the desktop settings of the previously active desktop from the desktop directory and the registry, and to import the desktop settings of the newly selected desktop into the desktop directory and the registry.

12. The memory of claim 10, wherein the program code is arranged to be executed in the framework of a Unix, Unix derivate or Linux operating system comprising a desktop manager providing a switchable-virtual-desktop mechanism.

13. The memory of claim 12, wherein the program code is arranged to control the desktop settings via an application programming interface of the desktop manager.

14. A memory storing a computer program for extending a computer's operating system which provides a virtual desktop, the computer program including program code, when executed, for tracking the time spent by the user working with the computer for different projects; the program code being arranged to:
extend the operating system's desktop functionality to a multi-desktop functionality, wherein the desktops are switchable by the user and are assignable to different projects;
track the time spent by the user working on the different desktops, thereby tracking the time spent on the projects to which the respective desktops are assigned.

15. The memory of claim 14, wherein the virtual desktops present link icons, and the program code is arranged to enable the user to define, as individual desktop settings, the link icons individually for the different project-assigned desktops, so that, upon switching from one of the desktops to another, different link icons are displayable.

16. The memory of claim 15, wherein the program code is arranged to be executed in the framework of a Microsoft Windows operating system comprising a desktop manager using a desktop directory and a registry, wherein the desktop settings are located in the desktop directory and in the registry, and wherein the program code is arranged, upon a switch from one virtual desktop to another, to export the desktop settings of the previously active desktop from the desktop directory and the registry, and to import the desktop settings of the newly selected desktop into the desktop directory and the registry.

17. A memory including a computer program for extending a computer's operating system which provides a plurality of virtual desktops switchable by a user, the computer program including program code, when executed, for tracking the time spent by the user working with the computer for different projects, wherein desktops are assigned to projects; the program code being arranged to:
track the time spent by the user working on the different desktops, thereby tracking the time spent on the projects to which the respective desktops are assigned.

18. The memory of claim 17, wherein the operating system to be extended is a Unix, Unix derivate or Linux operating system comprising a desktop manager providing a switchable-virtual-desktop mechanism.

19. The memory of claim 17, wherein the virtual desktops present link icons, and the program code is arranged to enable the user to define, as individual desktop settings, the link icons individually for the different project-assigned desktops, so that, upon switching from one of the desktops to another, different link icons are displayable.

20. The memory of claim 19, wherein the program code is arranged to control the desktop settings via an application program interface of a desktop manager.

21. A computer arranged to track the time spent by a user working with the computer for different projects, comprising:
a desktop manager arranged to provide a plurality of virtual desktops which are assignable to different projects and switchable by the user;
a project-time tracker arranged to individually track the time spent by the user working on the different desktops, thereby tracking the time spent on the projects to which the respective desktops are assigned.

22. A method of tracking the time spent by a user working with a computer for different projects, wherein the computer is arranged to provide a plurality of virtual desktops assigned to different projects; comprising:
working, by the user, on a desktop which is assigned to a currently handled project and switching to another of the desktops when another project is handled;
tracking, by the computer, the time spent by the user working on the different desktops, thereby tracking the time spent on the projects to which the respective desktops are assigned.

23. A memory storing a computer program including program code, when executed on a computer, for providing a graphical user interface with a plurality of virtual desktops presenting link icons to a user, the program code being arranged to:
provide the plurality of virtual desktops in a way that the user can switch from one to another as desired;
enable the user to define, as individual desktop settings, the link icons individually for the virtual desktops, so that, upon switching from one of the desktops to another, different link icons are displayable.

24. The memory of claim 23, wherein the program code is arranged to enable the user to determine further desktop settings, besides the link icons, individually for the virtual desktops, said further settings being at least one of: resources, positions of the link icons, and background pictures, so that, upon switching from one of the desktops to another, different desktop settings are active.

25. The memory of claim 23, wherein the program code is arranged, upon a switch from one virtual desktop to another, to:
store the desktop settings of the previously active desktop;
retrieve the desktop settings of the newly selected desktop;
use the retrieved desktop settings as current desktop settings for the newly selected desktop.

26. The memory of claim 25, wherein the program code is arranged to be executed in the framework of a Microsoft Windows operating system comprising a desktop manager using a desktop directory and a registry, wherein the desktop settings are located in the desktop directory and in the registry, and wherein the program code is arranged, upon a switch from one virtual desktop to another, to export the desktop settings of the previously active desktop from the desktop directory and the registry, and to import the desktop settings of the newly selected desktop into the desktop directory and the registry.

27. The memory of claim 25, wherein the program code is arranged to be executed in the framework of a Unix or Unix derivate operating system comprising a desktop manager providing a switchable-virtual-desktop mechanism.

28. The memory of claim 27, wherein the program code is arranged to control the desktop settings via an application programming interface of the desktop manager.

29. The memory of claim 23, wherein the program code is arranged to enable the user to assign the virtual desktops to different projects on which the user works; and
to individually track the time spent by the user working on the different desktops, thereby tracking the time spent on the projects to which the individual desktops are assigned.

30. A computer having a graphical user interface with a plurality of virtual desktops, comprising:
a desktop manager arranged to provide the plurality of virtual desktops switchable by the user;
wherein the virtual desktops present link icons, and wherein the desktop manager is arranged to enable the user to define the link icons individually for the virtual desktops, so that, upon switching from one of the desktops to another, different link icons are displayable.

31. A method of providing a user of a computer with a plurality of virtual desktops presenting link icons to the user, said virtual desktops being switchable by the user, comprising:
enabling the user to define the link icons individually for the virtual desktops; and,
displaying different link icons for the different desktops, according to the desktop-individual link-icon definition, in response to a switch being made from one desktop to another.

32. A computer program product comprising a data carrier with program code stored on it, when executed on a computer, for tracking the time spent by a user working with the computer for different projects, the program code being arranged to:
provide a plurality of virtual desktops which are assignable to different projects and switchable by the user;
track the time spent by the user working on the different desktops, thereby tracking the time spent on the projects to which the respective desktops are assigned.

33. A computer program product comprising a data carrier with program code stored on it for extending a computer's operating system which provides a virtual desktop, the computer program product including program code, when executed, for tracking the time spent by the user working with the computer for different projects; the program code being arranged to:
extend the operating system's desktop functionality to a multi-desktop functionality, wherein the desktops are switchable by the user and are assignable to different projects;
track the time spent by the user working on the different desktops, thereby tracking the time spent on the projects to which the respective desktops are assigned.

34. A computer program product comprising a data carrier with program code stored on it for extending a computer's operating system which provides a plurality of virtual desktops switchable by a user, the computer program product including program code, when executed, for tracking the time spent by the user working with the computer for different projects, wherein desktops are assigned to projects; the program code being arranged to:
track the time spent by the user working on the different desktops, thereby tracking the time spent on the projects to which the respective desktops are assigned.

35. A computer program product comprising a data carrier with program code stored on it, when executed on a computer, for providing a graphical user interface with a plurality of virtual desktops presenting link icons to a user, the program code being arranged to:
provide the plurality of virtual desktops in a way that the user can switch from one to another as desired;
enable the user to define, as individual desktop settings, the link icons individually for the virtual desktops, so that, upon switching from one of the desktops to another, different link icons are displayable.

36. A propagated signal carried on an electromagnetic waveform comprising a representation of program code, when executed on a computer, for tracking the time spent by a user working with the computer for different projects, the program code being arranged to:
provide a plurality of virtual desktops which are assignable to different projects and switchable by the user;
track the time spent by the user working on the different desktops, thereby tracking the time spent on the projects to which the respective desktops are assigned.

37. A propagated signal carried on an electromagnetic waveform comprising a representation of program code for extending a computer's operating system which provides a virtual desktop, the computer program including program code, when executed, for tracking the time spent by the user working with the computer for different projects; the program code being arranged to:
extend the operating system's desktop functionality to a multi-desktop functionality, wherein the desktops are switchable by the user and are assignable to different projects;
track the time spent by the user working on the different desktops, thereby tracking the time spent on the projects to which the respective desktops are assigned.

38. A propagated signal carried on an electromagnetic waveform comprising a representation of program code for extending a computer's operating system which provides a plurality of virtual desktops switchable by a user, the computer program including program code, when executed, for tracking the time spent by the user working with the computer for different projects, wherein desktops are assigned to projects; the program code being arranged to:
track the time spent by the user working on the different desktops, thereby tracking the time spent on the projects to which the respective desktops are assigned.

39. A propagated signal carried on an electromagnetic waveform comprising a representation of program code, when executed on a computer, for providing a graphical user interface with a plurality of virtual desktops presenting link icons to a user, the program code being arranged to:
provide the plurality of virtual desktops in a way that the user can switch from one to another as desired;
enable the user to define, as individual desktop settings, the link icons individually for the virtual desktops, so that, upon switching from one of the desktops to another, different link icons are displayable.
